(19) United States
(12) Patent Application Publication
(10) Pub. No.: US 2007/0121662 A1
(43) Pub. Date: May 31, 2007

(54) Network performance scaling

(76) Inventor: Christopher Leech, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/292,213

(22) Filed: Nov. 30, 2005

(51) Int. Cl. H04L 12/56

(52) U.S. Cl. 370/412

(57) ABSTRACT

In an embodiment, a method is provided. The method of this embodiment provides in response to receiving one or more packets on a computing platform, storing each of the one or more packets in a corresponding one of a plurality of receive queues, each of the plurality of receive queues corresponding to one of a plurality of processors on the computing platform; generating an interrupt to an operating system on the computing platform to indicate the presence of one or more packets to be processed; for each of the receive queues having one or more packets to be processed, scheduling a corresponding processing device structure with the operating system; and in response to the operating system processing scheduled transactions, for each of the processing device structures, sending packets from a corresponding receive queue to a corresponding one of the plurality of processors to be processed.

### FIELD

Embodiments of this invention relate to improved network performance scaling.

### BACKGROUND

The availability of multiple processors on a computational platform has largely increased the network performance of computer systems. In RSS (Receive Side Scaling), for example, a network controller may queue packets it receives off the network in receive queues, where each of the receive queues stores packets that will be processed by a corresponding one of the multiple processors. RSS is part of a future version of the Network Device Interface Specification (hereinafter “NDIS”) in the Microsoft® Windows® family of operating systems. As of the filing date of the subject application, the NDIS version that will include RSS capabilities is currently known to be NDIS 6.0 available from Microsoft® Corporation. RSS is described in “Scalable Networking With RSS”, WinHEC (Windows Hardware Engineering Conference) 2005, Apr. 19, 2005.

However, full integration of this solution requires, for example, that the operating system be compatible with and support a system that uses multiple receive queues.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates a computing platform.

FIG. 2 illustrates a network according to an embodiment.

FIG. 3 illustrates a computing platform according to an embodiment.

FIG. 4 is a flowchart illustrating a method according to an embodiment.

FIG. 5 is a flowchart illustrating a method according to an embodiment.

### DETAILED DESCRIPTION

Examples described below are for illustrative purposes only, and are in no way intended to limit embodiments of the invention. Thus, where examples may be described in detail, or where examples may be provided, it should be understood that the examples are not to be construed as exhaustive, and do not limit embodiments of the invention to the examples described and/or illustrated.

Briefly, an embodiment of the present invention relates to a computing platform comprising one or more network controllers to receive packets, and a plurality of processors to process the packets. In an embodiment, packets transmitted over a network may be received by a network component of a network controller. Network component may store each packet in one of a plurality of receive queues. Each receive queue may correspond to one of the processors that may process the packets stored on a given receive queue. To achieve compatibility with an operating system of the computing platform that may only be aware of a single-queued network component, a device driver associated with the network controller may create a processing device structure for each of the receive queues. As packets are stored on the receive queues, the device driver may indicate one or more of the receive queues to the operating system to be scheduled for packet processing by presenting the corresponding one or more processing device structures. However, this is merely an example embodiment of the present invention and other embodiments are not limited in these respects.

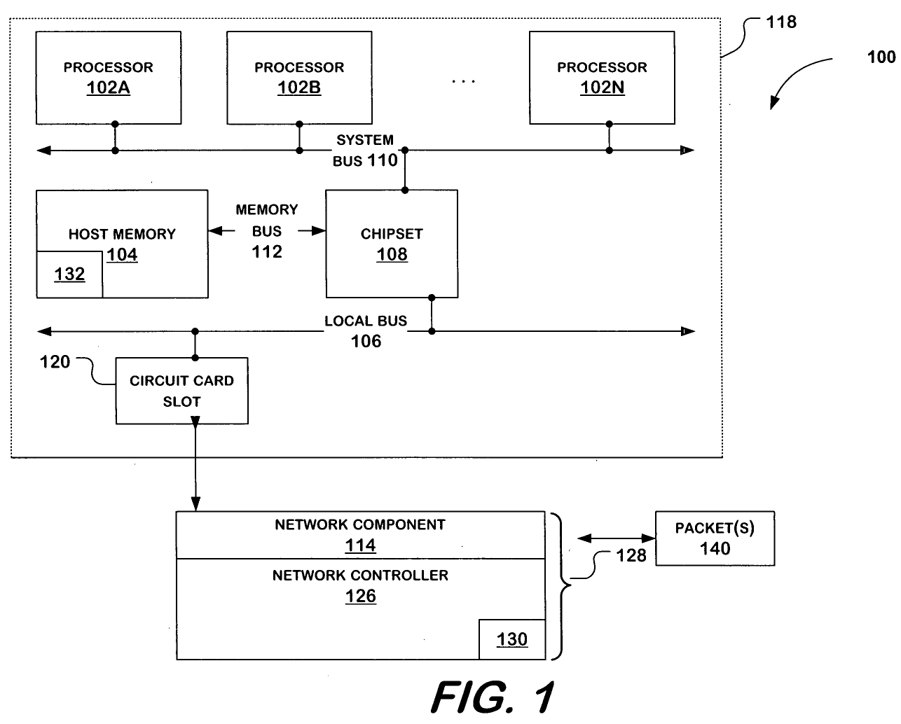

As illustrated in FIG. 1, computing platform 100 may comprise a plurality of processors 102A, 102B, . . . , 102N. A “processor” as discussed herein relates to a combination of hardware and software resources for accomplishing computational tasks. For example, a processor may comprise a system memory and processing circuitry (e.g., a central processing unit (CPU) or microcontroller) to execute machine-readable instructions for processing data according to a predefined instruction set. Alternatively, a processor may comprise just the processing circuitry (e.g., CPU). Another example of a processor is a computational engine that may be comprised in a multi-core processor, for example, where the operating system may perceive the computational engine as a discrete processor with a full set of execution resources. However, these are merely examples of processor and embodiments of the present invention are not limited in this respect.

Processors 102A, 102B, . . . , 102N may be part of an SMP (symmetrical multi-processing) system, and may comprise, for example, an Intel® Pentium® processor, or an Intel® Xeon™ processor, both commercially available from Intel® Corporation. Of course, alternatively, any of processors 102A, 102B, . . . , 102N may comprise another type of processor, such as, for example, a microprocessor that is manufactured and/or commercially available from Intel® Corporation, or a source other than Intel® Corporation, without departing from embodiments of the invention.

Memory 104 may store machine-executable instructions 132 that are capable of being executed, and/or data capable of being accessed, operated upon, and/or manipulated by logic, such as logic 130. “Machine-executable” instructions as referred to herein relates to expressions which may be understood by one or more machines for performing one or more logical operations. For example, machine-executable instructions may comprise instructions which are interpretable by a processor compiler for executing one or more operations on one or more data objects. However, this is merely an example of machine-executable instructions and embodiments of the present invention are not limited in this respect. Memory 104 may, for example, comprise read only, mass storage, random access computer-accessible memory, and/or one or more other types of machine-accessible memories. The execution of program instructions 132 and/or the accessing, operation upon, and/or manipulation of this data by logic 130 for example, may result in, for example, computing platform 100 and/or logic 130 carrying out some or all of the operations described herein.

Logic 130 may comprise hardware, software, or a combination of hardware and software (e.g., firmware). For example, logic 130 may comprise circuitry (i.e., one or more circuits), to perform operations described herein. Logic 130 may be hardwired to perform the one or more operations. For example, logic 130 may comprise one or more digital circuits, one or more analog circuits, one or more state machines, programmable logic, and/or one or more ASIC's (Application-Specific Integrated Circuits). Alternatively or additionally, logic 130 may be embodied in machine-executable instructions 132 stored in a memory, such as memory 104, to perform these operations. Alternatively or additionally, logic 130 may be embodied in firmware. Logic may be comprised in various components of computing platform 100, including network controller 126 (as illustrated), chipset 108, one or more processors 102A, 102B, . . . , 102N, and on motherboard 118. Logic 130 may be used to perform various functions by various components as described herein.

Chipset 108 may comprise a host bridge/hub system that may couple processor 102A, 102B, . . . , 102N, and host memory 104 to each other and to local bus 106. Chipset 108 may comprise one or more integrated circuit chips, such as those selected from integrated circuit chipsets commercially available from Intel® Corporation (e.g., graphics, memory, and I/O controller hub chipsets), although other one or more integrated circuit chips may also, or alternatively, be used. According to an embodiment, chipset 108 may comprise an input/output control hub (ICH), and a memory control hub (MCH), although embodiments of the invention are not limited by this. Chipset 108 may communicate with memory 104 via memory bus 112 and with host processor 102 via system bus 110. In alternative embodiments, host processor 102 and host memory 104 may be coupled directly to bus 106, rather than via chipset 108.

Local bus 106 may be coupled to a circuit card slot 120 having a bus connector (not shown). Local bus 106 may comprise a bus that complies with the Peripheral Component Interconnect (PCI) Local Bus Specification, Revision 3.0, Feb. 3, 2004 available from the PCI Special Interest Group, Portland, Oreg., U.S.A. (hereinafter referred to as a “PCI bus”). Alternatively, for example, bus 106 may comprise a bus that complies with the PCI Express™ Base Specification, Revision 1.1, Mar. 28, 2005 also available from the PCI Special Interest Group (hereinafter referred to as a “PCI Express bus”). Bus 106 may comprise other types and configurations of bus systems.

Computing platform 100 may additionally comprise one or more network controllers 126 (only one shown). A “network controller” as referred to herein relates to a device which may be coupled to a communication medium to transmit data to and/or receive data from other devices coupled to the communication medium, i.e., to send and receive network traffic. For example, a network controller may transmit packets 140 to and/or receive packets 140 from devices coupled to a network such as a local area network. As used herein, a “packet” means a sequence of one or more symbols and/or values that may be encoded by one or more signals transmitted from at least one sender to at least one receiver. Such a network controller 126 may communicate with other devices according to any one of several data communication formats such as, for example, communication formats according to versions of IEEE Std. 802.3, IEEE Std. 802.11, IEEE Std. 802.16, Universal Serial Bus, Firewire, asynchronous transfer mode (ATM), synchronous optical network (SONET) or synchronous digital hierarchy (SDH) standards.

Network controller 126 may comprise logic 130 to perform operations described herein. Network controller 126 may further be associated with a network component 114. A “network component” refers to a component on a computing platform that controls how network data is accessed. An example of a network component is a MAC (media access control) layer of the Data Link Layer as defined in the Open System Interconnection (OSI) model for networking protocols. The OSI model is defined by the International Organization for Standardization (ISO) located at 1 rue de Varembé, Case postale 56 CH-1211 Geneva 20, Switzerland. In an embodiment, network component (e.g., MAC) may be implemented on network controller 126, although embodiments of the invention are not limited in this respect. For example, network component (e.g., MAC) may instead be integrated with chipset 108 without departing from embodiments of the invention.

In an embodiment, network controller 126 may be comprised on system motherboard 118. Rather than reside on motherboard 118, network controller 126 may be integrated onto chipset 108, or may instead be comprised in a circuit card 128 (e.g., NIC or network interface card) that may be inserted into circuit card slot 120. Circuit card slot 120 may comprise, for example, a PCI expansion slot that comprises a PCI bus connector (not shown). PCI bus connector (not shown) may be electrically and mechanically mated with a PCI bus connector (not shown) that is comprised in circuit card 128. Circuit card slot 120 and circuit card 128 may be constructed to permit circuit card 128 to be inserted into circuit card slot 120. When circuit card 128 is inserted into circuit card slot 120, PCI bus connectors (not shown) may become electrically and mechanically coupled to each other. When PCI bus connectors (not shown) are so coupled to each other, logic 130 in circuit card 128 may become electrically coupled to system bus 110.

In an embodiment, network controller 126 may be communicatively coupled to local bus 106. Rather than be communicatively coupled to local bus 106, network controller 126 may instead be communicatively coupled to a dedicated bus on the MCH of chipset 108. For example, dedicated bus may comprise a bus that complies with CSA (Communication Streaming Architecture). CSA is a communications interface technology developed by Intel® that directly connects the MCH to the network controller to improve the transfer rate of network data and to eliminate network traffic passing through the PCI bus. As used herein, components that are “communicatively coupled” means that the components may be capable of communicating with each other via wirelined (e.g., copper or optical wires), or wireless (e.g., radio frequency) means.

Computing platform 100 may comprise more than one, and other types of memories, buses, processors, and network controllers. For example, computing platform 100 may comprise a server having multiple processors 102A, 102B, . . . , 102N and multiple network controllers 126. Processors 102A, 102B, . . . , 102N, memory 104, and busses 106, 110, 112 may be comprised in a single circuit board, such as, for example, a system motherboard 118, but embodiments of the invention are not limited in this respect.

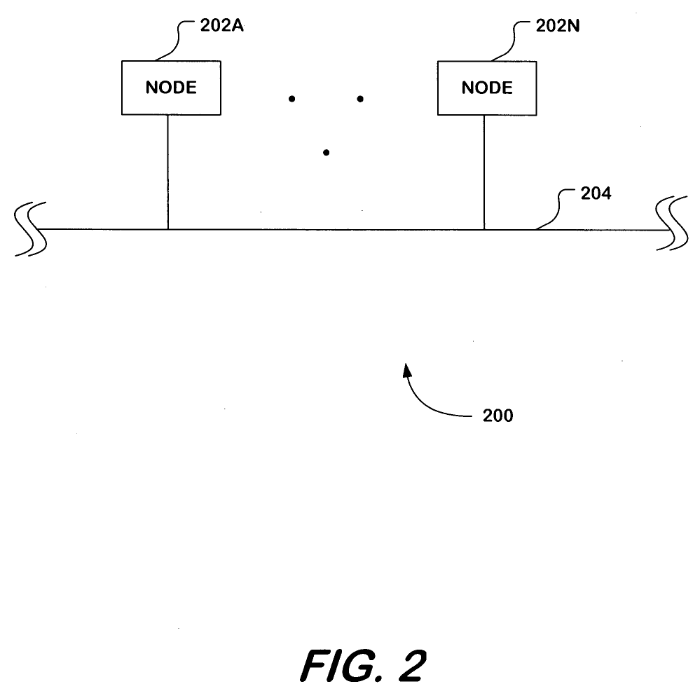

FIG. 2 illustrates a network 200 in which embodiments of the invention may operate. Network 200 may comprise a plurality of nodes 202A, . . . 202N, where each of nodes 202A, . . . , 202N may be communicatively coupled together via a communication medium 204. Nodes 202A . . . , 202N may transmit and receive sets of one or more signals via medium 204 that may encode one or more packets. Communication medium 104 may comprise, for example, one or more optical and/or electrical cables, although many alternatives are possible. For example, communication medium 104 may comprise air and/or vacuum, through which nodes 202A . . . 202N may wirelessly transmit and/or receive sets of one or more signals.

In network 200, one or more of the nodes 202A . . . 202N may comprise one or more intermediate stations, such as, for example, one or more hubs, switches, and/or routers; additionally or alternatively, one or more of the nodes 202A . . . 202N may comprise one or more end stations. Also additionally or alternatively, network 200 may comprise one or more not shown intermediate stations, and medium 204 may communicatively couple together at least some of the nodes 202A . . . 202N and one or more of these intermediate stations. Of course, many alternatives are possible.

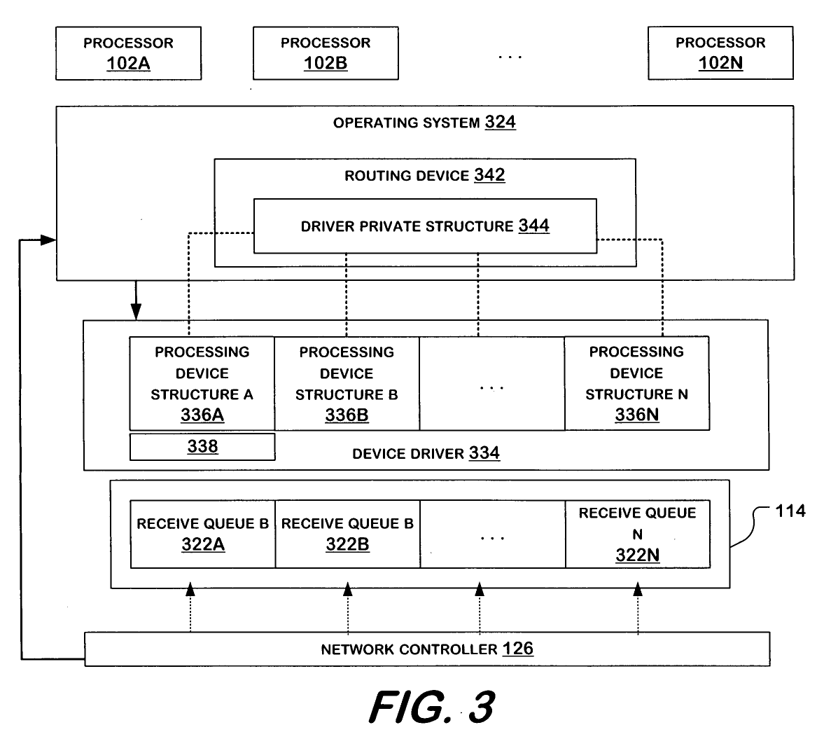

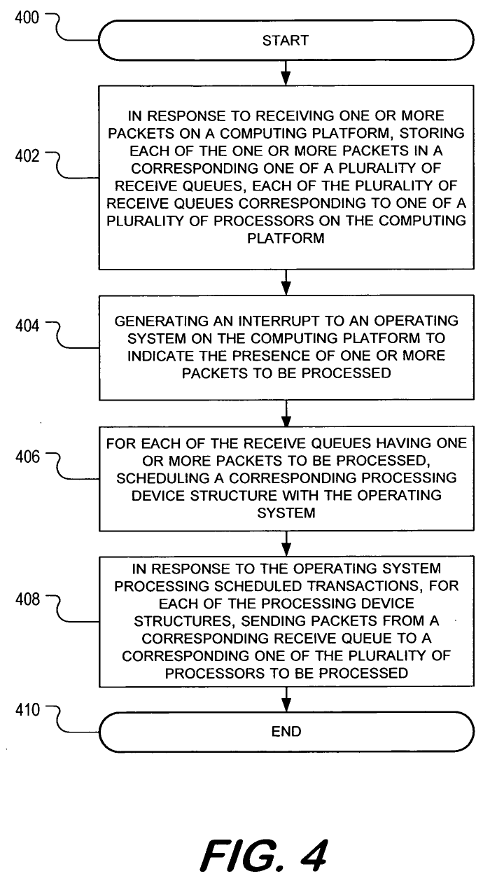

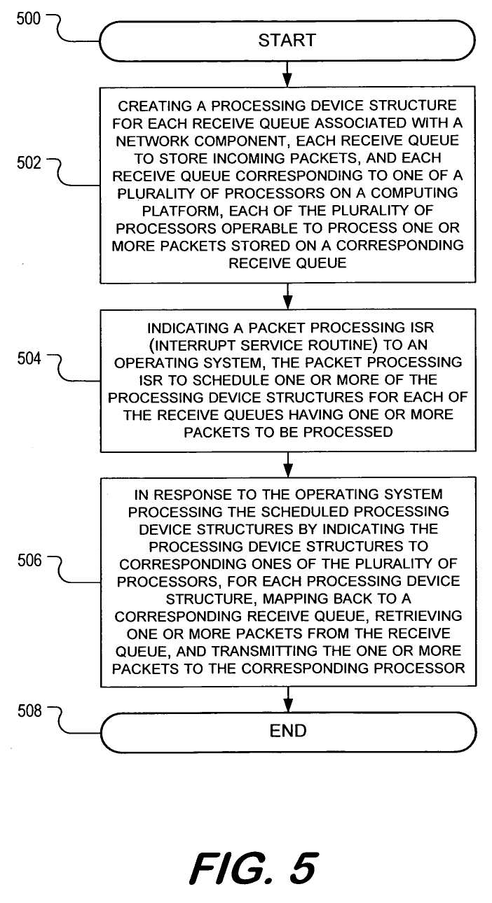

FIG. 3 illustrates a computing platform according to at least one embodiment of the invention as described in the flowcharts illustrated FIGS. 4 and 5.

A method according to an embodiment is illustrated in FIG. 4. The method of FIG. 4 begins at block 400 and continues to block 402 where the method may comprise in response to receiving one or more packets on a computing platform, storing each of the one or more packets in a corresponding one of a plurality of receive queues, each of the plurality of receive queues corresponding to one of a plurality of processors on the computing platform.

For example, one or more packets 140 may be stored in a corresponding one of plurality of receive queues 322A, 322B, . . . , 322N of network component 114, where each of the plurality of receive queues 322A, 322B, . . . , 322N correspond to one of plurality of processors 102A, 102B, . . . , 102N on computing platform 100.

Receive queues 322A, 322B, . . . , 322N may be associated with network component 114. For example, network component 114 may have references (e.g., pointers, or descriptors) to receive queues 322A, 322B, . . . , 322N that may be stored in a memory, such as memory 104, or on network controller 126, for example.

In an embodiment, the one or more packets 140 may be stored in a corresponding one of a plurality of receive queues 322A, 322B, . . . , 322N of network component 114 by storing receive descriptors in the receive queues 322A, 322B, . . . , 322N, where the receive descriptors provide a mechanism (e.g., pointer) by which the packets may be accessed.

Each receive queue 322A, 322B, . . . , 322N may store one or more packets 140 and may correspond to one of processors 102A, 102B, . . . , 102N that may process packets 140 stored on a given receive queue 322A, 322B, . . . , 322N. A given receive queue 322A, 322B, . . . , 322N that corresponds to a processor 102A, 102B, . . . , 102N means that a corresponding processor 102A, 102B, . . . , 102N may process receive packets 140 that are queued on the given receive queue 322A, 322B, . . . , 322N.

In an embodiment, such as in an RSS environment, network controller 126 may receive a packet 140, and may generate an RSS hash value. This may be accomplished by performing a hash function over one or more header fields in the header of the packet 140. The hash function may comprise a Toeplitz hash as described in the WinHEC Apr. 19, 2005 white paper. One or more header fields of packet 140 may be specified for a particular implementation. For example, the one or more header fields used to determine the RSS hash value 112 may be specified by NDIS. NDIS is a Microsoft® Windows® device driver that enables a single network controller, such as a NIC, to support multiple network protocols, or that enables multiple network adapters to support multiple network protocols. The current version of NDIS is NDIS 5.1, and is available from Microsoft® Corporation of Redmond, Wash. A subsequent version of NDIS, known as NDIS 6.0 available from Microsoft® Corporation, which is to be part of the new version of Microsoft® Windows® currently known as the “Scalable Networking Pack” for Windows Server 2003, includes various technologies not available in the current version, such as RSS.

An indirection table may be implemented, such as on network controller 126, to direct receive packets 140 to a receive queue 322A, 322B, . . . , 322N. Indirection table may comprise one or more entries, where each entry may comprise a value based, at least in part, on receive packet 140, and where each value may correspond to a receive queue 322A, 322B, . . . , 322N. In an RSS environment, for example, indirection table may comprise an RSS hash value (or subset thereof) and a corresponding receive queue 322A, 322B, . . . , 322N, where the RSS hash value may be based, at least in part, on a receive packet 140. A subset of the RSS hash value may be mapped to an entry in an indirection table to determine a receive queue 322A, 322B, . . . , 322N, which may determine a corresponding processor 102A, 102B, . . . , 102N.

At block 404, the method may comprise generating an interrupt to an operating system on the computing platform to indicate the presence of one or more packets to be processed. In an embodiment, operating system may only have knowledge of a single receive queue, and may not be able to process packets sent from multiple receive queues. In an embodiment, by way of example, operating system may comprise a Linux operating system. Linux is freely available to the general public, and may be, for example, downloaded from various sources. By way of another example, operating system may alternatively comprise pre-RSS versions of Microsoft® Windows®.

Network controller 126 may signal an interrupt to operating system 324 to indicate the presence of packets 140 to be processed. Interrupt may be sent in accordance with an interrupt moderation scheme. An interrupt moderation scheme refers to a rule that controls when an interrupt is to be sent to operating system 324. For example, an interrupt moderation scheme may dictate that an interrupt be sent to operating system 324 when n packets have been received and are ready to be processed. Interrupt may be processed by any one of processors 102A, 102B, . . . , 102N. In an embodiment, interrupts may be processed by a selected one of processors 102A, 102B, . . . , 102N.

At block 406, the method may comprise for each of the receive queues having one or more packets to be processed, scheduling a corresponding processing device structure with the operating system.

For example, for each of receive queues 322A, 322B, . . . , 322N having packets 140 to be processed, a processing device structure 336A, 336B, . . . , 336N corresponding to each receive queue 322A, 322B, . . . , 322N may be scheduled with operating system 324. Processing device structures 336A, 336B, . . . , 336N may be created by device driver 334 when network controller 126 is initialized to provide an interface between operating system 324 and device driver 334.

In an embodiment, scheduling may be in response to a packet processing interrupt service routine 338 (ISR) that executes in response to an interrupt to operating system 324. ISRs, including ISR 338, may be set up by device driver 324 when network controller 126 is initialized, where each ISR may be triggered by different events. In an embodiment, execution of packet processing ISR 338 may result in one or more packets 140 being scheduled for processing on corresponding processors 102A, 102B, . . . , 102N based, at least in part, on a receive queue 322A, 322B, . . . , 322N on which the one or more packets 140 are stored.

For example, when packet processing ISR 338 executes, it may determine which receive queues 322A, 322B, . . . , 322N have packets to be processed. Packet processing ISR 338 may schedule the corresponding processing device structures 336A, 336B, . . . , 336N by indicating to operating system 324 that a device has packets to process. Operating system 324 may add the processing device structures 336A, 336B, . . . , 336N to its list of devices that need processing, and may track which processors 102A, 102B, . . . , 102N to use for each processing device structure 336A, 336B, . . . , 336N.

At block 408, the method may comprise in response to the operating system processing scheduled transactions, for each of the processing device structures, sending packets from a corresponding receive queue to a corresponding one of the plurality of processors to be processed.

When operating system 324 gets around to network processing, operating system 324 may indicate processing device structures 336A, 336B, . . . 336N to corresponding processors 102A, . . . , 102N. At each processor 102A, 102N having a processing device structure 336A, 336B, . . . , 336N, processing device structure 336A, 336B, . . . , 336N may call back to device driver 334 to request packets 140 waiting for processing. Device driver 33 may comprise a mapping from the processing device structure 336A, 336B, . . . , 336N to a corresponding receive queue 322A, 322B, . . . , 322N. Device driver 334 may then start pulling packets off the receive queue 322A, 322B, . . . , 322N and return packets 140 to operating system 324 on corresponding processor 102A, 102B, . . . , 102N as part of the call back. Thereafter, each processor 102A, 102B, . . . , 102N may process packets 140 sent to processor 102A, 102B, . . . , 102N by device driver 334 via corresponding processing device structures 336A, 336B, . . . , 336N.

The method may end at block 410.

In an embodiment, an SMP system may be employed in which computing platform 100 may comprise a plurality of processors 102A, 102B, . . . , 102N and a plurality of network controllers 126 (only one shown). In this embodiment, device driver 334 may load routing device structure 342. Routing device structure 342 may be used in an SMP system for egress route selection. Egress route selection refers to the selection of one of a plurality of network controllers 126 for transmitting packets over a network connection. For example, network controller 126 may be selected based on a destination address of the packets 140. Routing device structure 342 may be created and registered with operating system 324 so that routing device structure 342 is visible to computing platform 100. Routing device structure 342 may be called by, and may call into, operating system 324. Routing device structure 342 may be used as an entry point into device specific information to protect operating system 324 and applications from device specifics.

Device driver 334 may load one or more driver private structures 344 that are not visible to computing platform 100, and may link driver private structures 344 to routing device structure 342 so that they are only visible to routing device structure 342. Driver private structures 344 may, for example, further insulate operating system 324 from device specifics, and may protect device specific information from corruption from other processes. Driver private structures 344 may store information specific to a device, such as network controller 126, such as hardware configuration information related to network controller 126. In an embodiment, a driver private structure 344 is created for each network controller 126. Upon loading of processing device structures 336A, 336B, . . . , 336N, device driver 334 may link each of processing device structures 336A, 336B, . . . , 336N to each driver private structure 344.

Alternatively, in an embodiment, one of processing device structures 336A, 336B, . . . , 336N may be registered with operating system 324, and may be used as both an egress and ingress packet processing interface between operating system 324 and device driver 324. The others of processing device structures 336A, 336B, . . . , 336N may be linked to this bidirectional processing device structure.

A method according to an embodiment is shown in FIG. 5. The method of FIG. 5 begins at block 500 and continues to block 502 where the method may comprise creating a processing device structure for each receive queue associated with a network component, each receive queue to store incoming packets, and each receive queue corresponding to one of a plurality of processors on a computing platform, each of the plurality of processors operable to process one or more packets stored on a corresponding receive queue.

For example, device driver 334 may create processing device structure 336A, 336B, . . . , 336N for each receive queue 322A, 322B, . . . , 322N associated with a network component 114. Each receive queue 322A, 322B, . . . , 322N may store packets 140, and may correspond to one of processors 102A, 102B, . . . , 102N on computing platform 100. Network controller 126 may be any one of a plurality of network controllers 126 on computing platform 100.

At block 504, the method may comprise indicating a packet processing ISR (interrupt service routine) to an operating system, the packet processing ISR to schedule one or more of the processing device structures for each of the receive queues having one or more packets to be processed.

For example, device driver 338 may indicate packet processing ISR 338 to operating system 324, and packet processing ISR 338 may result in one or more packets 140 being scheduled for processing on corresponding processors 102A, 102B, . . . , 102N based, at least in part, on a receive queue 322A, 322B, . . . , 322N on which the one or more packets 140 are stored.

At block 506, the method may comprise in response to the operating system processing the scheduled processing device structures by indicating the processing device structures to corresponding ones of the plurality of processors, for each processing device structure, mapping back to a corresponding receive queue, retrieving one or more packets from the receive queue, and transmitting the one or more packets to the corresponding processor.

For example, operating system 324 may process the scheduled processing device structures 336A, 336B, . . . , 336N by indicating the processing device structures 336A, 336B, . . . , 336N to corresponding ones of processors 102A, 102B, . . . , 102N. In response, for each of the processing device structures 336A, 336B, . . . , 336N, device driver 334 may use the processing device structures 336A, 336B, . . . , 336N to map back to a receive queue 322A, 322B, . . . , 322N that corresponds to a given processing device structure 336A, 336B, . . . , 336N, retrieve packets 140 from the receive queue 322A, 322B, . . . , 322N, and transmit the packets 140 to the corresponding processor 102A, 102B, . . . , 102N.

The method may end at block 508.

### CONCLUSION

Therefore, in an embodiment, a method may comprise in response to receiving one or more packets on a computing platform, storing each of the one or more packets in a corresponding one of a plurality of receive queues, each of the plurality of receive queues corresponding to one of a plurality of processors on the computing platform; generating an interrupt to an operating system on the computing platform to indicate the presence of one or more packets to be processed; for each of the receive queues having one or more packets to be processed, scheduling a corresponding processing device structure with the operating system; and in response to the operating system processing scheduled transactions, for each of the processing device structures, sending packets from a corresponding receive queue to a corresponding one of the plurality of processors to be processed.

Embodiments of the invention may enable an operating system to process packets queued on a plurality of receive queues associated with a MAC, for example, even though the operating system may only have knowledge of a single-queued MAC. This is accomplished by exposing each receive queue as an independent network device by using processing device structures as an interface between the operating system and the device driver. This eliminates a complex set of requirements that would otherwise need to be implemented for a multi-queued MAC. For example, it eliminates the need to modify the operating system to make it aware of multi-queued MACs.

In the foregoing specification, the invention has been described with reference to specific embodiments thereof. It will, however, be evident that various modifications and changes may be made to these embodiments without departing therefrom. The specification and drawings are, accordingly, to be regarded in an illustrative rather than a restrictive sense.

What is claimed is:

1. A method comprising:
in response to receiving one or more packets on a computing platform, storing each of the one or more packets in a corresponding one of a plurality of receive queues, each of the plurality of receive queues corresponding to one of a plurality of processors on the computing platform;
generating an interrupt to an operating system on the computing platform to indicate the presence of one or more packets to be processed;
for each of the receive queues having one or more packets to be processed, scheduling a corresponding processing device structure with the operating system; and
in response to the operating system processing scheduled transactions, for each of the processing device structures, sending packets from a corresponding receive queue to a corresponding one of the plurality of processors to be processed.

2. The method of claim 1, wherein the operating system comprises a Linux operating system.

3. The method of claim 1, wherein said scheduling a corresponding processing device structure with the operating system comprises the operating system executing a packet processing ISR (interrupt service routine) in response to the interrupt generated to the operating system.

4. The method of claim 3, wherein the packets are received by a network component of a network controller, and the ISR is created by a device driver that controls the network controller.

5. A method comprising:
create a processing device structure for each receive queue associated with a network component, each receive queue to store incoming packets, and each receive queue corresponding to one of a plurality of processors on a computing platform, each of the plurality of processors operable to process one or more packets stored on a corresponding receive queue;
indicate a packet processing ISR (interrupt service routine) to an operating system, the packet processing ISR to schedule one or more of the processing device structures for each of the receive queues having one or more packets to be processed;
in response to the operating system processing the scheduled processing device structures by indicating the processing device structures to corresponding ones of the plurality of processors, for each processing device structure, mapping back to a corresponding receive queue, retrieving one or more packets from the receive queue, and transmitting the one or more packets to the corresponding processor.

6. The method of claim 5, wherein the operating system comprises a Linux operating system.

7. The method of claim 5, wherein each processing device structure is linked to one or more driver private structures, and each driver private structure is linked to a routing device structure, wherein the driver private structures and the routing device structure are used in an SMP (symmetrical multi-processing) system for egress packet processing.

8. The method of claim 5, wherein network component is part of a network controller, and the ISR is created by a device driver that controls the network controller.

9. An apparatus comprising:
logic to:
create a processing device structure for each receive queue associated with a network component, each receive queue to store incoming packets, and each receive queue corresponding to one of a plurality of processors on a computing platform, each of the plurality of processors operable to process one or more packets stored on a corresponding receive queue;
indicate a packet processing ISR (interrupt service routine) to an operating system, the packet processing ISR to schedule one or more of the processing device structures for each of the receive queues having one or more packets to be processed;
in response to the operating system processing the scheduled processing device structures by sending the processing device structures to corresponding ones of the plurality of processors, for each processing device structure, mapping back to a corresponding receive queue, retrieving one or more packets from the receive queue, and transmitting the one or more packets to the corresponding processor.

10. The apparatus of claim 9, wherein the operating system comprises a Linux operating system.

11. The apparatus of claim 9, wherein each processing device structure is linked to one or more driver private structures, and each driver private structure is linked to a routing device structure, wherein the driver private structures and the routing device structure are used in an SMP (symmetrical multi-processing) system for egress packet processing.

12. The apparatus of claim 9, wherein the network component is part of a network controller, and the ISR is created by a device driver that controls the network controller.

13. A system comprising:
a Microsoft® Windows® operating system having knowledge of a single receive queue associated with a network component;
a network controller to interface with the operating system; and
a device driver to control the network controller, the device driver having logic to:
create a processing device structure for each receive queue associated with a network component of the network controller, each receive queue to store incoming packets, and each receive queue corresponding to one of a plurality of processors on a computing platform, each of the plurality of processors operable to process one or more packets stored on a corresponding receive queues;
indicate a packet processing ISR (interrupt service routine) to the operating system, the packet processing ISR to schedule one or more of the processing device structures for each of the receive queues having one or more packets to be processed;
in response to the operating system processing the scheduled processing device structures by sending the processing device structures to corresponding ones of the plurality of processors, for each processing device structure, mapping back to a corresponding receive queue, retrieving one or more packets from the receive queue, and transmitting the one or more packets to the corresponding processor.

14. The system of claim 13, wherein the operating system comprises a Linux operating system.

15. The system of claim 13, wherein the system comprises an SMP (symmetrical multi-processing) system, and each processing device structure is linked to one or more driver private structures, and each driver private structure is linked to a routing device structure, wherein the driver private structures and the routing device structure are used in egress packet processing.

16. The system of claim 13, wherein network component is part of a network controller, and the ISR is created by a device driver that controls the network controller.

17. An article of manufacture having stored thereon instructions, the instructions when executed by a machine, result in the following:
create a processing device structure for each receive queue associated with a network component, each receive queue to store incoming packets, and each receive queue corresponding to one of a plurality of processors on a computing platform, each of the plurality of processors operable to process one or more packets stored on a corresponding receive queue;
indicate a packet processing ISR (interrupt service routine) to an operating system, the packet processing ISR to schedule one or more of the processing device structures for each of the receive queues having one or more packets to be processed;
in response to the operating system processing the scheduled processing device structures by indicating the processing device structures to corresponding ones of the plurality of processors, for each processing device structure, mapping back to a corresponding receive queue, retrieving one or more packets from the receive queue, and transmitting the one or more packets to the corresponding processor.

18. The article of claim 17, wherein the operating system comprises a Linux operating system.

19. The article of claim 17, wherein each processing device structure is linked to one or more driver private structures, and each driver private structure is linked to a routing device structure, wherein the driver private structures and the routing device structure are used in an SMP (symmetrical multi-processing) system for egress packet processing.

20. The article of claim 17, wherein network component is part of a network controller, and the ISR is created by a device driver that controls the network controller.
